(19) United States
(12) Patent Application Publication
(10) Pub. No.: US 2008/0286433 A1
(43) Pub. Date: Nov. 20, 2008

(54) Beverages Comprising a Rice Extract, Derivatives Thereof, or Combinations Thereof

(75) Inventors: Tyler Simpson, Smyrna, GA (US); Valerie Mercier, Smyrna, GA (US)

Correspondence Address: SUTHERLAND ASBILL & BRENNAN LLP, 999 PEACHTREE STREET, N.E., ATLANTA, GA, 30309, US

(73) Assignee: The Cola-Cola Company, Atlanta, GA (US)

(21) Appl. No.: 12/117,842

(22) Filed: May 9, 2008

Related U.S. Application Data
(60) Provisional application No. 60/938,963, filed on May 18, 2007.

(51) Int. Cl. A23L 2/00; A23L 1/052; A23L 1/05; A23J 3/22; A23L 2/38

(52) U.S. Cl. 426/569; 426/590; 426/577; 426/573; 426/576

(57) ABSTRACT

A beverage comprising at least one flavoring and a rice extract, a derivative thereof, or combinations thereof is provided. The beverage has a cream-like mouthfeel. A method of providing a beverage which imparts a cream-like mouthfeel is also provided. The method comprises providing a rice milk product and adding at least one flavoring to the rice milk product is also provided. A beverage comprising at least one flavoring, a thickener, and a rice extract is further provided.

### CROSS-REFERENCE TO RELATED APPLICATIONS

This application claims priority under 35 U.S.C. § 119(e) to U.S. Provisional Patent Application No. 60/938,963, filed on May 18, 2007, the disclosure of which are expressly incorporated herein by reference.

### TECHNICAL FIELD

This invention generally relates to beverages comprising a rice extract, derivatives thereof, or combinations thereof.

### BACKGROUND OF THE INVENTION

Current lifestyles have become more active and busy to the point were consumers are looking to portable, “on-the-go”, forms of foods and beverages which are traditionally consumed at home or in a restaurant while seated. For example, there are products now which allow the consumer to drink soup or yogurt while commuting or outside their home or outside of a restaurant setting. Consumer consumption of sparkling or carbonated beverages, non-carbonated beverages, and juices has been widespread and includes use in single or two serving packages. Likewise, improvements in recipes for packaged goods such as ice-cream, pies, cakes, and desserts has also contributed to the popularity of such packaged goods among consumers and packaging of such goods in single serving sizes. However, the possibilities of improvement on the variety of offerings of sparkling beverages, non-carbonated beverages, and juices have not been exhausted. The variety of portable desserts also has not been exhausted.

In addition, some consumers may be limited in their choice of food or beverage because of restrictions on their fat intake, calorie intake, dairy intake, or glucose intake. Other consumers may limit their fat intake, calorie intake, or dairy intake based on lifestyle choices or taste preferences. An active or busy lifestyle may also compound the problem of consumers not being able to have their first choice, or maybe even any choice, in food or beverage product that they consume “on the go.” Accordingly there is a need to expand the possible offerings of food and beverages, including portable or single serving form.

### SUMMARY OF THE INVENTION

The present disclosure encompasses a beverage comprising at least one flavoring and a rice extract, a derivative thereof, or combinations thereof. The beverage has a cream-like mouthfeel.

The present disclosure also encompasses a method of providing a beverage which imparts a cream-like mouthfeel. The method comprises providing a rice milk product and adding at least one flavoring to the rice milk product.

The present disclosure further includes a beverage comprising at least one flavoring, a thickener, and a rice extract.

The present disclosure additionally includes a beverage comprising a rice extract and at least one flavoring which imparts a flavor to the beverage substantially similar to a dessert, a fruit, or combinations thereof.

Other objects, features, and advantages of this invention will be apparent from the following detailed description and claims.

### DETAILED DESCRIPTION OF THE EMBODIMENTS

As summarized above, this disclosure encompasses a beverage comprising at least one flavoring and a rice extract, a derivative thereof, or combinations thereof and a method for providing a beverage which imparts a cream-like mouthfeel.

The flavoring which imparts a flavor to the beverage may be any suitable flavoring. In some embodiments, the flavoring may impart a flavor substantially similar to a dessert, a fruit, or combinations thereof. Examples of suitable fruit flavors include, but are not limited to orange, grape, strawberry, banana, pineapple, mango, other fruit flavors, or combinations thereof. Suitable dessert flavors for embodiments of the present invention include flavors normally associated with ice-cream, pie, cake, pudding, or combinations thereof. In one embodiment, the flavor substantially masks the taste of the rice extract. In another embodiment the flavoring imparts a flavor selected from the group consisting of strawberries and cream, key lime pie, and orange and cream.

The rice extract may be any liquid extracted from or derived from whole grain brown rice, whole grain white rice, or any other type of rice. As used herein, “rice extract” refers to rice extracts, derivatives thereof, and combinations thereof. For example, the rice extract may be a liquid, a solid formed by spray drying a liquid, an enzymatically treated rice extract, or any substance formed by further processing of a rice extract. In particular embodiments, the rice extract comprises a liquid, a concentrated liquid, a syrup, a powder, or combinations thereof. Non-limiting examples of rice extract include the rice extracts disclosed in U.S. Pat. Nos. 4,894,242 and 4,744,992 and U.S. Patent Application Publication No. 2007/0014892, each to Mitchell et al., all of which are hereby incorporated by reference. In another embodiment, the rice extract comprises solids comprising carbohydrates, starch, protein, fiber, fat, and combinations thereof. As referred to herein, “solids” includes any solid or semi-solid component which may be present in the rice extract as a result of the extraction from the rice(s). Examples of commercially available rice extracts include RiceLife™ Powder FF, RiceLife™ Brown Rice Syrup, and RiceLife™ Whole Grain Brown Rice Concentrate from Creative Research Management (Stockon, Calif.).

According to particular embodiments, the rice extract solids are present in the beverage in an amount ranging from 0.2% by weight per volume of the beverage to 10% by weight per volume of the beverage. According to other embodiments, the rice extract solids are present in the beverage in an amount ranging from 1% by weight per volume of the beverage to 4% by weight per volume of the beverage. According to still other embodiments, the rice extract solids are present in the beverage in an amount ranging from 1.8% by weight per volume of the beverage to 2.2% by weight per volume of the beverage. It should be understood by a person of ordinary skill in the art that some forms of the rice extract include water and thus the weight percent of the rice extract would need to be adjusted so that the solids content in the rice extract in the beverage is consistent with the ranges provided above.

Without being bound by theory, if the rice extract is a liquid concentrate rice extract, larger quantities may need be added in order to achieve the desired rice extract content. For example, a liquid concentrate rice extract may have about 30% solids, so that a final range of 0.2% to 8% by weight per volume rice extract solids content in the beverage would require larger quantities of the liquid concentrate as compared to rice extract comprising less water. If a powdered rice extract is used, additional considerations may include consideration of solubilizing the rice extract powder in the beverage, longer processing time due to handling of the powder when adding it to a liquid, and/or modifications to the beverage to compensate for rice off-notes or to increase stability. Use of a rice extract syrup may not require consideration of the issues related to the liquid concentrate rice extract and/or the powder as mentioned above. A rice extract syrup may be easily solubilized in the beverage, may taste cleaner, may have a significant decrease in sedimentation, may allow for easier processing, and/or impart little to no off-notes of rice or old rice. Reduction of off-taste may allow better control of other components of the beverage and allow for an improved taste in the beverage.

In particular embodiments, the beverage provides a texture different from water when consumed by a consumer. For example, embodiments of the beverage may have a cream-like mouthfeel. As used herein, the term “cream-like mouthfeel” refers to a fatty, smooth, creamy taste with a thick and rich mouthfeel. In some embodiments, the texture of the beverage is substantially similar to the texture of cream or custard. Thus, in particular embodiments, the beverage comprises an indulgent beverage, “any-time-dessert-treat,” or “dessert-you-can-drink.” In some embodiments, the beverage is a dairy-free, low caloric, low fat beverage as a result of the use of rice extract rather than a dairy or fat product to achieve a desired texture and taste.

In some embodiments, the beverage may additionally include a thickener. As referred to herein, “thickener” may include any material which increases the viscosity of the beverage or increases the cream-like mouthfeel of the beverage. Examples of suitable thickeners for use in the present invention include, but are not limited to carbohydrates, proteins, fats, lipids, hydrocolloids, gums, and combinations thereof. For example, the thickener may comprise gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose, microcrystalline cellulose, carboxymethylcellulose gum, gelatin, chitosan, maltodextrin, or combinations thereof. In one embodiment, the thickener may comprise a combination of xantham gum and pectin.

In particular embodiments, the thickeners may be present in a range of 0% by weight per volume of the beverage to 4% by weight per volume of the beverage. In more particular embodiments, the thickeners may be present in a range of 0% by weight per volume of the beverage to about 0.7% by weight per volume of the beverage.

In particular embodiments, the beverage may also comprise a stabilizer, an acid, a preservative, a coloring, carbonated water, additives, or combinations thereof, for example. For instance, embodiments of the beverage may comprise a preservative comprising sodium benzoate, potassium sorbate, or combinations thereof. In particular embodiments, the preservatives may be present in a range of 0% by weight per volume of the beverage to 0.11% by weight per volume of the beverage, In more particular embodiments, the preservatives may be present in a range of 0% by weight per volume of the beverage to about 0.06% by weight per volume of the beverage.

In another embodiment, the beverage may comprise an additives, including, but not limited to, SHMP, citric acid, sodium citrate, or combinations thereof. In one embodiment, the beverage may include no SHMP or preservatives (e.g., sodium benzoate or potassium sorbate). In particular embodiments which include no SHMP, the beverage's stability may be improved.

In some embodiments, the beverage may include a sweetener such as sucrose, fructose, or glucose. Natural high-potency sweeteners suitable for embodiments of the present invention include rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukuroziosude, phlomisoside I, periandrin I, abrusoside A, cyclocarioside I, and combinations thereof, for instance. Examples of other suitable sweeteners for use in the present invention may include artificial sweeteners such as sucralose, acesulfame potassium or other salts, aspartame, alitame, saccharin, neohesperidin dihydrochalcone, cyclamate, neotame, N—[N-[3-(3-hydroxy-4-methoxyphenyl)propyl]-L-α-aspartyl]-L-phenylalanine 1-methyl ester, N—[N-[3-(3-hydroxy-4-methoxyphenyl)-3-methylbutyl]-L-α-aspartyl]-L-phenylalanine 1-methyl ester, N—[N-[3-(3-methoxy-4-hydroxyphenyl)propyl]-L-α-aspartyl]-L-phenylalanine 1-methyl ester, salts thereof, and the like.

In particular embodiments, the sweeteners may be present in a range of 0% by weight per volume of the beverage to 16% by weight per volume of the beverage. In more particular embodiments, the sweeteners may be present in a range of 9% by weight per volume of the beverage to about 14% by weight per volume of the beverage.

As used herein, “beverage” refers to any composition which is potable and consumable to humans without being toxic when used in quantities normally associated with such a composition. In particular embodiments, the beverage may include an additional component selected from the group consisting of water, flavored water, flavored beverages, carbonated water, syrup, diet beverages, carbonated soft drinks, fruit juices, fruit containing beverages, fruit flavored beverages containing generally recognized flavorants, vegetable juices, vegetable containing beverages, isotonic beverages, non-isotonic beverages, soft drinks containing a fruit juice, coffee, tea, dairy products, soy products, and combinations thereof. According to particular embodiments of the present invention, the beverage can comprise beverage formulations already in use to provide well-known or familiarly flavored drinks, such as cola, diet cola, lemon-lime, orange, orange juice, beer, and root beer, for example. In other embodiments of the present invention, the beverage may also include components selected from the group consisting of lactose, maltose, high fructose corn syrup, fructose, dextrose, salt, nonfat milk solids, whey solids, and combinations thereof.

It should be understood by a person of ordinary skill in the art that the beverages may be made by any method suitable for making beverages.

Other embodiments are further illustrated below in the examples which are not to be construed in any way as imposing limitations upon the scope of this disclosure. On the contrary, it is to be clearly understood that resort may be had to various other embodiments, modifications, and equivalents thereof which, after reading the description therein, may suggest themselves to those skilled in the art without departing from the scope of this disclosure and the appended claims.

### EXAMPLE 1

A beverage in accordance with an embodiment of the present invention can be having the formulation tabulated below in Table 1.

TABLE 1

| | | % w/v | % w/v |
|---|---|---|---|
| | % w/v | More | Most |
| | Preferred | Preferred | Preferred |
| Ingredients | Range | Range | embodiment |
| Rice Extract Solids | 0.200-10.00 | 1.000-4.000 | 2.000 |
| Preservatives | 0.000-0.110 | 0.000-0.060 | 0.049 |
| SHMP | 0.000-0.150 | 0.000-0.080 | 0.070 |
| Thickeners | 0.000-4.000 | 0.000-0.700 | 0.350 |
| Citric Acid, Sodium | 0.20-1.40 | 0.20-0.80 | 0.44 |
| Citrate, Color(s), | | | |
| Flavor(s) | | | |
| Dimethylpolysiloxane | 0.0000- | 0.00030- | 0.0005 |
| | 0.0010 | 0.00090 | |
| Sweeteners | 0.0-16.0 | 9.0-14.0 | 12.00 |
| Carbonation Level | 0.0-4.0 | 0.0-3.0 | 2.3 Volumes |
| | Volumes | Volumes | |

### EXAMPLE 2

A beverage in accordance with an embodiment of the present invention was made having a Brix of 14.3, a carbonation of 2.5, a pH of 3.5, and the formulation provided below in Table 2.

TABLE 2

| Ingredient | % w/v |
|---|---|
| Rice Extract Powder | 2.00 |
| Thickeners | 0.352 |
| Preservatives | 0.049 |
| SHMP | 0.082 |
| Citric Acid, Sodium | 0.561 |
| Citrate, Colors, Flavors | |

### EXAMPLE 3

A beverage in accordance with an embodiment of the present invention was made having a Brix of 14.3, a carbonation of 2.25, a pH of 3.5, and the formulation provided below in Table 3.

TABLE 3

| Ingredient | % w/v |
|---|---|
| RiceLife ™ Brown Rice Syrup | 2.00 |
| Thickeners | 0.35 |
| Preservatives | 0.078 |
| SHMP | 0.07 |
| Citric Acid, Sodium Citrate, | 0.392 |
| Colors, Flavors | |

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

We claim:

1. A beverage comprising:
at least one flavoring; and
a rice extract, a derivative thereof, or combinations thereof, wherein the beverage has a cream-like mouthfeel.

2. The beverage of claim 1, wherein the flavor substantially masks the taste of the rice extract.

3. The beverage of claim 1, wherein the at least one flavoring imparts a flavor selected from the group consisting of orange, grape, strawberry, banana, pineapple, mango, flavors normally associated with ice-cream, pie, cake, or pudding, and combinations thereof.

4. The beverage of claim 1, wherein the rice extract comprises a liquid, a concentrated liquid, a syrup, a powder, or combinations thereof.

5. The beverage of claim 1, wherein the rice extract comprises solids comprising carbohydrates, starch, protein, fiber, fat, or combinations thereof.

6. The beverage of claim 5, wherein the solids are present in an amount ranging from 0.2% by weight per volume of the beverage to about 8% by weight per volume of the beverage.

7. The beverage of claim 1, wherein the rice extract is derived from whole grain brown rice, whole grain white rice, or combinations thereof.

8. The beverage of claim 1, further comprising a thickener.

9. The beverage of claim 8, wherein the thickener is selected from the group consisting of gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose, microcrystalline cellulose, carboxymethylcellulose gum, gelatin, chitosan, maltodextrin, and combinations thereof.

10. The beverage of claim 1, wherein the beverage provides a texture different from water when consumed by a consumer.

11. The beverage of claim 1, wherein the texture is substantially similar to the texture of cream or custard.

12. The beverage of claim 1, wherein the beverage is a dairy-free, low calorie, low fat beverage.

13. A method of providing a beverage which imparts cream-like mouthfeel comprising:
providing a rice extract; and
adding at least one flavoring to the rice extract.

14. The method of claim 13, wherein the at least one flavoring imparts a flavor selected from the group consisting of orange, grape, strawberry, banana, pineapple, mango, flavors normally associated with ice-cream, pie, cake, or pudding, and combinations thereof.

15. The method of claim 13, wherein the rice extract comprises a liquid, a concentrated liquid, a syrup, a powder, or combinations thereof.

16. The method of claim 13, wherein the rice extract comprises solids comprising carbohydrates, starch, protein, fiber, fat, or combinations thereof.

17. The method of claim 13, wherein the solids are present in an amount ranging from 0.2% by weight per volume of the beverage to about 8% by weight per volume of the beverage.

18. The method of claim 13, wherein the rice extract is derived from whole grain brown rice, whole grain white rice, or combinations thereof.

19. The method of claim 13, further comprising adding a thickener to beverage.

20. The method of claim 19, wherein the thickener is selected from the group consisting of gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose, microcrystalline cellulose, carboxymethylcellulose gum, gelatin, chitosan, maltodextrin, and combinations thereof.

21. The method of claim 13, wherein the texture is substantially similar to the texture of cream or custard.

22. The method of claim 13, wherein the beverage is a dairy-free, low calorie, low fat beverage.

23. A beverage comprising:
at least one flavoring;
a thickener; and
a rice extract.

24. The beverage of claim 23, wherein the thickener comprises pectin, xanthan gum, or combinations thereof.

25. A beverage comprising:
at least one flavoring which imparts a flavor to the beverage substantially similar to a dessert, a fruit, or combinations thereof; and
a rice extract.
